(19) United States
(12) Patent Application Publication
(10) Pub. No.: US 2011/0147375 A1
(43) Pub. Date: Jun. 23, 2011

(54) INDUCTORS ON BALANCED PHASES

(76) Inventor: Stéphane Lomp, Chartres (FR)

(21) Appl. No.: 12/975,516

(22) Filed: Dec. 22, 2010

(30) Foreign Application Priority Data
Dec. 23, 2009 (FR) 0959545

(51) Int. Cl. H05B 6/36

(52) U.S. Cl. 219/672

(57) ABSTRACT

The disclosure relates to cooking apparatus by induction including:
at least two combustion points, each combustion point comprising at least two inductors; and
a generator, connected on one side to an electric power source delivering at least two electric phases and on the other side to the inductors of the combustion points for controlling the electric power supplied to the inductors;
wherein the inductors of the same combustion point are each fed by a different phase.

### CROSS-REFERENCE TO RELATED APPLICATIONS

This application claims the benefit and priority of French Application Serial No. 0959545, filed on Dec. 23, 2009, which is incorporated by reference herein.

### BACKGROUND AND SUMMARY

The invention relates in general to cooking apparatus by induction. More particularly, the invention relates to cooking apparatus whereof the electrical feed is a source containing at least two phases.

It is known that heating by induction consists of generating currents known as “Foucault” currents in a piece conducting electricity by means of a magnetic field. The magnetic field is generated by an inductor, adapted to the zone of the piece to be heated, through which an alternating current generally runs. The alternating current running through the inductor is itself produced by a generator, controlled by a control unit which adapts the frequency and amplitude of the current to ensure preferred heating. In the case of cooking by induction, the item to be heated is a cooking vessel made of electrically conductive material.

Even though the invention described herein below can be applied to a magnetic materials of copper or aluminium type, greater focus here is on heating of magnetic materials (soft steel, iron, magnetic stainless steel, . . . ). The container generally has a diameter of between 90 and 280 mm and a thickness of between 1 and 4 mm for public applications. Diameters can reach 450 mm and the thickness 10 mm for professional or industrial applications.

In reference to FIG. 1, this shows an apparatus known from the prior art, comprising:

One or more combustion points F1 and F2, each combustion point capable of containing one or more inductors I11, I12, I21 and I22. The function of these inductors is to generate a magnetic field destined for a cooking container as explained earlier.

A generator G, connected on one side to an electric power source, such as a domestic or professional electrical network providing one or more electric phases, and on the other side to the inductors of the combustion points for controlling electric power supplied to the inductors. In this way the generator helps regulate the electric power destined for the inductors so as to control the magnetic field coming from the inductors.

Generally, the electronic concept of the generator is such that all the combustion points of the cooking apparatus are fed by only one of the phases of the electrical source. However, such an electronic concept engenders imbalances in the electrical network as all loads come back to a single phase. It is also known to have an electronic concept such that the combustion points are each fed by a different phase (all the inductor of the same combustion point are fed by the same phase). However, this solution fails to resolve the problem of load imbalance on the phases when all the combustion points are not being used.

Also, in the event where not all the combustion points of the cooking apparatus are in use, the user would then have to utilise some combustion points rather than others to avoid load imbalance on all the phases of the source. This selection of combustion points to be used would depend both on the phase which feeds the different combustion points and also on the power consumed by the combustion points being used. Yet, on the other hand the aim is not to subject the user to any restriction in the choice of some combustion points over others when the apparatus is being used, but it is possible that the user is forced to use some combustion points for reasons of available space or cooking power required.

So, an aim of the present invention is to provide cooking apparatus by induction which can guarantee load balance in the different phases of the source, irrespective of the number of combustion points in use and irrespective of the power of the combustion point or combustion points being used. To this end, the invention relates to cooking apparatus by induction comprising:
at least two combustion points, each combustion point comprising at least two inductors,
a generator, connected on one side to an electric power source delivering at least two electric phases and on the other side to the inductors of the combustion points for controlling the electric power supplied to the inductors,
wherein the inductors of the same combustion point are each fed by a different phase.

Advantageously and optionally, the invention comprises at least one of the following characteristics:
the two combustion points are arranged such that two adjacent inductors are each fed by a different phase,
a first inductor of a first combustion point is connected to a first phase,
a first inductor from the second combustion point is connected to a second phase,
the second inductors of each combustion point are each connected a relay for switching between an electrical feed coming from the first phase or from the second phase,
the generator comprises two outlets each corresponding to a different phase,
the first inductor of a first combustion point is connected to the first outlet of the generator,
the first inductor of the second combustion point is connected to a second outlet of the generator,
the second inductors of each combustion point are each connected to a relay for switching between an electrical feed coming from the first outlet or from the second outlet,
the apparatus comprises two other relays respectively linked to the first inductor of the first combustion point and to the first inductor from the second combustion point, these two relays connecting or disconnecting these first inductors to or from the corresponding outlet of the generator,
the two phases are generated from one phase and from a neutral of the same electrical network,
the two phases are generated from two phases of the same electrical network,
the generator comprises transistors of IGBT type and/or of IGBT type with power unit grille.

### BRIEF DESCRIPTION OF THE DRAWINGS

Other characteristics, aims and advantages of the present invention will emerge from the following detailed description, in reference to the attached Figures given by way of non-limiting examples and in which:

FIG. 1 is a schematic illustration of cooking apparatus according to the prior art;

FIG. 2 is a schematic illustration of cooking apparatus according to a possible embodiment of the present invention;

FIG. 3 is a schematic illustration of cooking apparatus according to a possible embodiment of the present invention;

FIG. 4 is a schematic illustration of cooking apparatus according to another possible embodiment of the present invention; and

FIGS. 5a and 5b are detailed schematic illustrations of the cooking apparatus of FIG. 4.

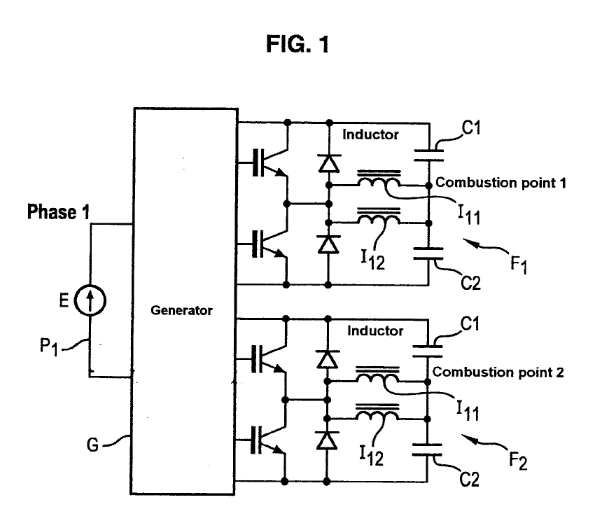

### DETAILED DESCRIPTION

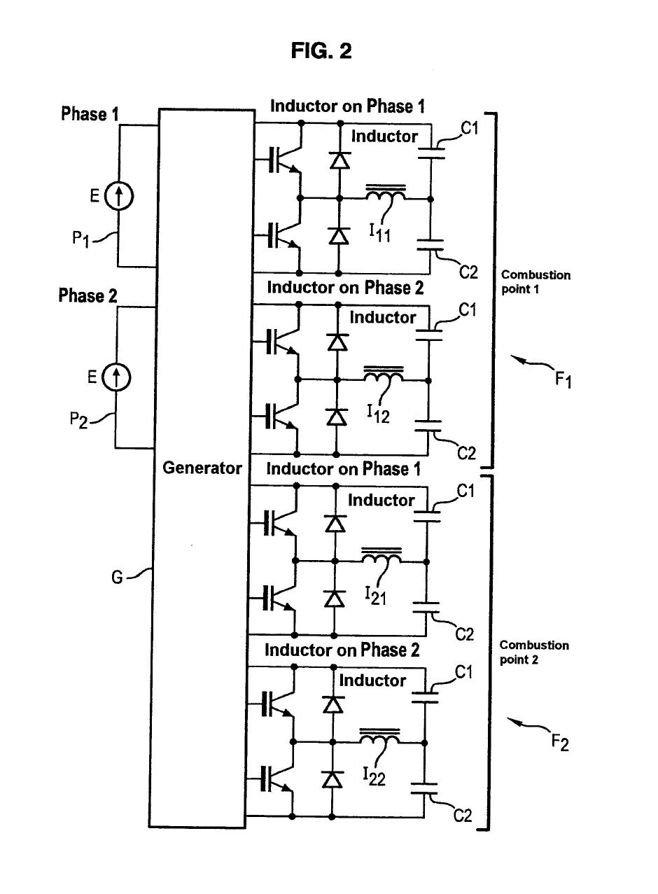

In reference to FIG. 2, and according to a possible embodiment of the present invention, a cooking apparatus by induction comprises:
at least two combustion points Fl and F2, each combustion point comprising at least two inductors: I11 and I12 for the combustion point F1; I21 and I22 for the combustion point F2,
a generator G, connected on one side to an electric power source delivering at least two electric phases P1 and P2 and on the other side to the inductors of the combustion points for controlling the electric power supplied to the inductors. Obviously, in the event where the apparatus is switched onto a conventional domestic or professional electrical network delivering an alternating signal, this signal is transformed previously into continuous signals with the aim of constituting an electrical source useable by the generator G. According to a particular embodiment, provision can be made for an alternating/continuous transformer integrated into the generator G, in which case the generator G is switched onto the conventional domestic or professional electrical network outputting an alternating signal. The generator G comprises generally a plurality of electronic components (for example switches, transistors, such as MOSFET, thyristors or preferably IGBT and more preferably IGBT with power unit grille “Trench IGBT” according to English terminology) which supply the inductor with electric power controlled (generally by frequency) so as to engender a magnetic field adequate for the required cooking.

Used generators can be classified into two major categories: resonance inverters generally used for European networks under 230V, mono-interrupter generators generally used for Japanese networks under 120V. In all cases, the inductor is connected to a condenser to create a resonance circuit which compensates its strong reactive component.

The source is composed of two phases P1 and P2 which are the supply sources of the inductors via the generator. The phases of the source are implemented from phases of a multiphase domestic or professional electrical network (for example a triphase 230/400V network). Generally, the multiphase electrical network supplies alternative feed (generally at 50 or 60 Hz): in this case, detection of the feed is provided between the network and the source to obtain phases P1 and P2 the voltage of which is continuous. Such detection is well known from the prior art and will not be explained hereinbelow.

According to a first embodiment, the two phases P1 and P2 are generated from one phase and from a neutral of the same multiphase electrical network. According to another embodiment, the two phases P1 and P2 are two phases of the same multiphase electrical network. According to the invention, the inductors of the same combustion point are each fed by a different phase. So, for the combustion point F1, the inductor I11 is fed by the phase P1 and the inductor I12 is fed by the phase P2; for the combustion point F2, the inductor I21 is fed by the phase P1 and the inductor I22 is fed by the phase P2.

As a consequence, where one of both combustion points or both combustion points are used simultaneously, the load is automatically balanced over all the phases. In fact, each combustion point has its feed shared between each of the phases P1 and P2, and no restriction is imposed on the user of the cooking apparatus by induction as to the use of each of the combustion points: irrespectively of the combustion point or combustion points used by the user, the load is balanced over all the phases. For example, where a combustion point of 3000 W power is used, the electric power consumed is distributed to apply a load of 1500 W on each phase.

According to a particular embodiment of the present invention, the two combustion points F1 and F2 are arranged such that two adjacent inductors are each fed by a different phase. In the case illustrated in FIG. 2, the inductor I12 of the combustion point Fl and the inductor I21 of the combustion point F2 are adjacent and are each fed by a different phase, respectively the phase P2 and the phase P1. So, the user can also use an intermediate combustion point composed of the inductors I12 and I21.

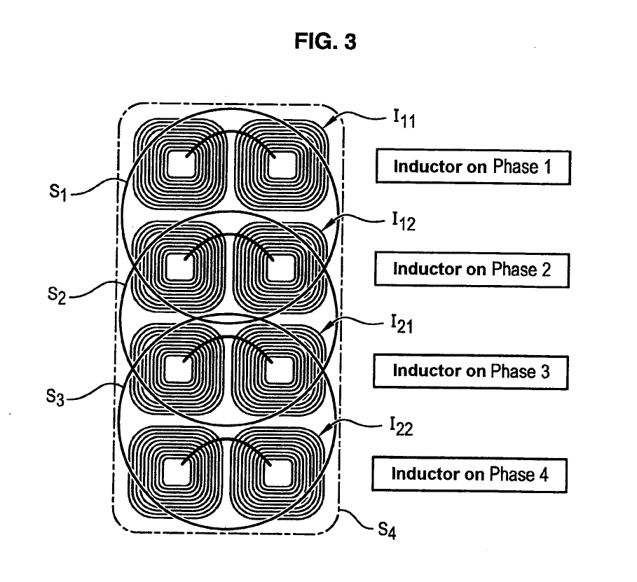

FIG. 3 illustrates a cooking apparatus as per the invention. The apparatus comprises four inductors I11, I12, I21 and I22 aligned in this order, and whereof a first phase P1 feeds the inductors I11 and I21 and a second phase P2 feeds the inductors I12 and I22. As a consequence, the user has three different placements S1, S2 and S3 for placing the cooking container. Irrespectively of the position chosen by the user, the load will be distributed effectively on the two phases P1 and P2. It is evident that the user also has the placement S4 comprising all four inductors I11, I12, I21 and I22, which carry dishes having an elongated form. On this placement S4, the load is also distributed over the phases P1 and P2.

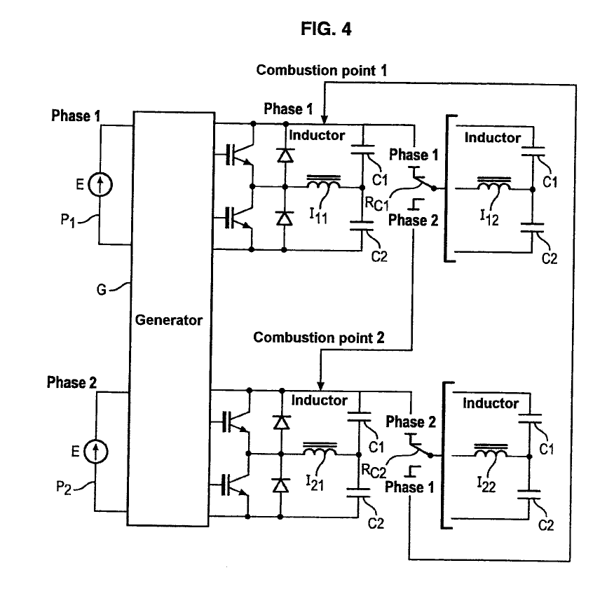

In reference to FIG. 4 and according to another possible embodiment of the present invention, the cooking apparatus by induction comprises two combustion points F1 and F2, a first inductor I11 of the first combustion point F1 is connected to a first phase P1 and the first inductor I21 of the second combustion point F2 is connected to a second phase P2. The second inductors I12 and I22 of each combustion point, respectively F1 and F2 are each connected to a relay respectively Rc1 and Rc2 for switching between an electrical feed coming from the first phase P1 or from the second phase P2.

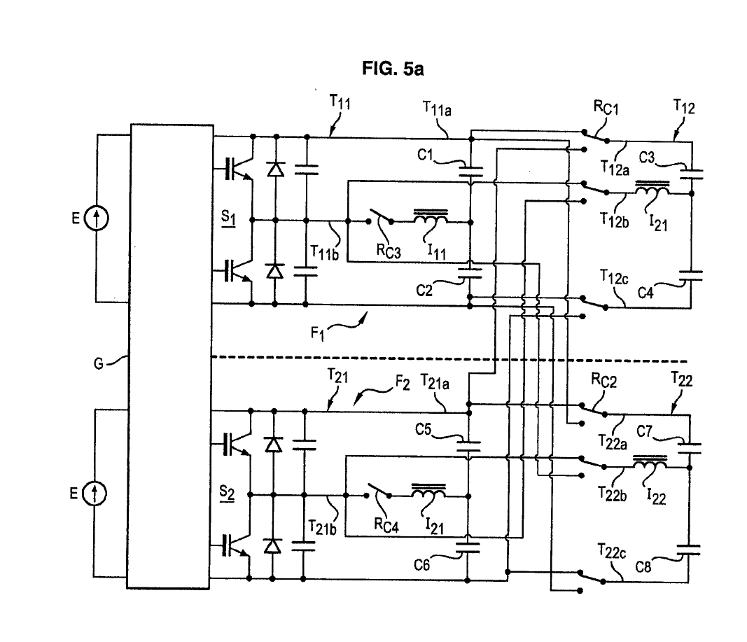

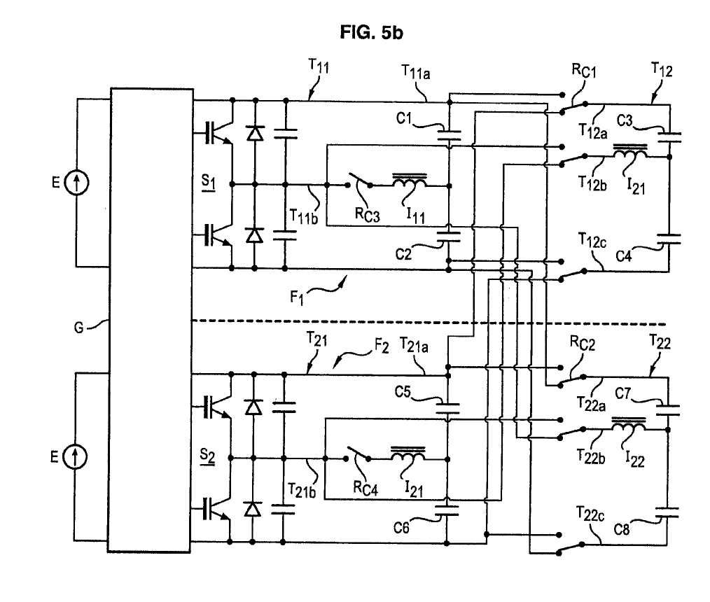

In reference to FIGS. 5a and 5b showing a particular embodiment of the apparatus of FIG. 4, the latter comprises at least two combustion points F1 and F2, each combustion point comprising at least two inductors, respectively I11, I12 and I21, I22. The device also comprises a generator G, connected on one side to an electric power source outputting at least two electric phases P1 and P2 and on the other side to the inductors of the combustion points for controlling the electric power supplied to the inductors. A first inductor I11 of the first combustion point F1 is connected to a first phase P1 and the first inductor I21 of the second combustion point F2 is connected to a second phase P2. More precisely, the generator comprises two outlets S1 and S2, each comprising three outlet terminals (respectively T11a, T11b, T11c and T21a, T21b T21c). The inductors I11 and I21 are connected respectively to the outlets S1 and S2 by means of capacitors (respectively C1, C2 and C5, C6). The electronic array between the outlet of the generator, the inductor and the capacitors is known from the prior art and will not be further explained.

The term “power unit” means a portion of the electronic array comprising an inductor, each power unit comprising terminals for feeding the inductor. Thus, the power unit T12 comprises the inductor I12 and the power unit T22 comprises the inductor I22.

The device also comprises two relays Rc1 and Rc2 linked respectively to the inductors I12 and I22 and able to assume two different positions:
a first position shown in FIG. 5a for connecting the power unit T12 comprising the inductor I12 and the capacitors C3 and C4 to the outlet S1 by connecting the terminals T12a, T12b and T12c of the power unit T12 respectively to the terminals T11a, T11b, T11c of the outlet S1; and for connecting the power unit T22 comprising the inductor I22 and the capacitors C7 and C8 to the outlet S2 by connecting the terminals T22a, T22b and T22c of the power unit T22 respectively to the terminals T21a, T21b, T21c of the outlet S2 (therefore the two inductors of the same combustion point are fed by the same phase)
a second position shown in FIG. 5b for connecting the power unit T12 to the outlet S2 by connecting the terminals T12a, T12b and T12c of the power unit T12 respectively to the terminals T21a, T21b, T21c of the outlet S2; and for connecting the power unit T22 to the outlet S1 by connecting the terminals T22a, T22b and T22c of the power unit T22 respectively to the terminals T11a, T11b, T11c of the outlet S1 (therefore the two inductors of the same combustion point are fed by a different phase).

Accordingly, such apparatus moves from one electronic array according to the prior art (FIG. 5a) to an electronic array according to the invention (FIG. 5b) by means of an external switch. Also, this apparatus needs only two outlets for the generator instead of four as in the embodiment shown in FIG. 2. As a consequence, the apparatus needs fewer electronic power elements and is thus less expensive and simpler than the apparatus shown in FIG. 2.

In reference again to FIGS. 5a and 5b, the apparatus also comprises two relays Rc3 and Rc4 linked respectively to the inductors I11 and I21. Each of these two relays electrically connects to or disconnects from the inductor linked to the corresponding outlet of the generator G. This type of arrangement operates only the inductors I12 and I22 (in the event where the inductor I11 and I21 are disconnected from the outlets S1 and S2). In the event where these two inductors I12 and I22 are adjacent and form an intermediate combustion point straddling the combustion points F1 and F2, only this intermediate combustion point is fed. Since the inductors I12 and I22 are each fed by a different phase, using this intermediate combustion point does not unbalance the load on the phases P1 and P2.

What is claimed is:

1. A cooking apparatus by induction comprising:
at least two combustion points, each combustion point comprising at least two inductors; and
a generator, connected on one side to an electric power source delivering at least two electric phases and on the other side to the inductors of the combustion points for controlling the electric power supplied to the inductors;
wherein the inductors of the same combustion point are each fed by a different phase.

2. The apparatus as claimed in claim 1 in which the two combustion points are arranged such that two adjacent inductors are each fed by a different phase.

3. The apparatus as claimed in claim 1 in which:
a first inductor of a first combustion point is connected to a first phase;
a first inductor from the second combustion point is connected to a second phase; and
in which the second inductors of each combustion point are each connected to a relay for switching between an electrical feed coming from the first phase or from the second phase.

4. The apparatus as claimed in claim 3, in which the generator comprises two outlets each corresponding to a different phase, in which:
the first inductor of a first combustion point is connected to the first outlet of the generator;
the first inductor of the second combustion point is connected to a second outlet of the generator;
the second inductors of each combustion point each being connected to a relay for switching between an electrical feed coming from one of: the first outlet and the second outlet.

5. The apparatus as claimed in claim 4, which comprises two other relays respectively linked to the first inductor of the first combustion point and to the first inductor of the second combustion point, these two relays connecting or disconnecting these first inductors to or from the corresponding outlet of the generator.

6. The apparatus as claimed in claim 1, in which the two phases are generated from one phase and from a neutral of the same electrical network.

7. The apparatus as claimed in claim 1, in which the two phases are generated from two phases of the same electrical network.

8. The apparatus as claimed in claim 1, in which the generator comprises transistors of at least one of: an IGBT type and an IGBT type with a power unit grille.
